(19) United States
(12) Patent Application Publication
(10) Pub. No.: US 2012/0125523 A1
(43) Pub. Date: May 24, 2012

(54) REPAIR METHOD FOR A SANDWICH-LIKE COMPONENT

(75) Inventor: Juergen DUPRE, Zeesen (DE)

(73) Assignee: ROLLS-ROYCE DEUTSCHLAND LTD & CO KG, Blankenfelde-Mahlow (DE)

(21) Appl. No.: 13/299,797

(22) Filed: Nov. 18, 2011

(30) Foreign Application Priority Data
Nov. 18, 2010 (DE) 10 2010 051 842.5

(51) Int. Cl. B32B 43/00; B32B 38/16

(52) U.S. Cl. 156/98

(57) ABSTRACT

A gas-turbine casing includes a sandwiched structure of a wall 30, a honeycomb structure 31 and a top layer 29, with the wall 30, the honeycomb structure 31 and the top layer 29 being bonded by epoxy resin. A repair method for the casing includes a first working step where the top layer 29 and the honeycomb structure 31 are removed mechanically in an area to be repaired. Afterwards, the surface of the wall 30 is cleaned of the epoxy resin by a laser beam. In a further working step, at least one prefabricated replacement piece is bonded in place.

This application claims priority to German Patent Application DE102010051842.5 filed Nov. 18, 2010, the entirety of which is incorporated by reference herein.

This invention relates to a repair method for a sandwich-like component, in particular for a sandwich-like component with a thin wall which can for example be made of titanium and which is bonded with a honeycomb structure.

A bypass casing of a gas-turbine engine is usually assembled from several parts, for example forged rings for the front and the rear flanges and a milled part made of titanium arranged between the forged rings. To reduce sound emissions, a honeycomb structure is arranged on the inside and is closed by a perforated top layer. The honeycomb structure and the top layer are thus connected sandwich-like to the wall, the bond being achieved by an epoxy resin.

Due to various events, damage to the top layer and/or to the honeycomb structure might occur. This will necessitate a local repair.

Up to a certain size of the damaged area, the latter can be filled up with a repair compound, for example a two-component compound (“blue filler”). In doing so, the contour is again adapted accordingly.

Due to a repair of this type, the function layer of the top layer or of the honeycomb structure is limited in respect of its sound emissions. Hence the entire surface that can be repaired in this way is considerably restricted.

Above a certain size of the damaged area, a replacement or substitution of the area affected is required. It is necessary here to remove and replace the top layer and/or the honeycomb structure. An operation of this nature requires however the removal, without leaving any traces, of both the top layer with the honeycomb structure, and the adhesive layer comprising epoxy resin.

The removal in particular of the adhesive layer is achieved according to the state of the art mechanically using a scraper. This however carries a high risk of irreparable damage to the wall, in particular because the latter can have a very low wall thickness, locally for example only 0.2 mm.

A chemical removal of the adhesive layer is also disadvantageous, since limitation of the area to be repaired is either not possible or inadequate due to the spreading of the solvent. There is thus a risk that adjacent areas of the adhesive layer are also affected by the solvent and/or removed.

Furthermore, it is not possible with the procedures known from the state of the art to repair cracks in the wall. This applies in particular to cracks in the area of the flanges. It must also be taken into account here that the wall can have very large thickness changes, with very thin-walled areas of, for example, 0.2 mm to relatively thick areas.

The solution provided by the prior art as a repair option thus allows for a replacement either of the entire component or of a part of the wall. This has proven to be very cost-intensive.

The present invention, in a broad aspect, provides a repair method of the type specified at the beginning, which, while being simply designed and easily and cost-effectively practicable, enables dependable repairing.

It is thus provided in accordance with the invention that in a first working step the top layer and the honeycomb structure in an area to be repaired are removed mechanically. This mechanical removal can comprise the entire honeycomb structure. It is, however, also possible that an area of the honeycomb structure close to the wall remains unaffected.

In the following, the epoxy resin layer used for bonding the honeycomb structure to the wall is removed in accordance with the invention by a laser beam. The energy applied by the laser beam removes the epoxy resin dependably and without a trace, the resin being “evaporated” by the locally applied energy. If during this working step there are still residues of the honeycomb structure on the area to be cleaned, they are dissolved and can likewise be removed.

Thereafter, a prefabricated and precisely fitting replacement piece is inserted and bonded in accordance with the invention in a further working step.

It is thus possible in accordance with the invention to replace geometrically precisely predetermined areas of the sandwich-like structure without running the risk of the wall itself being damaged.

In a development of the method in accordance with the invention, it is provided that after cleaning of the surface of the wall the cracks present in this wall are closed by a laser beam. Thus it is possible to weld the cracks using the same device if necessary. This closing or welding of the cracks can be achieved in accordance with the invention preferably by using a filler material.

It can be favorable in accordance with the invention when the welded or closed areas of the cracks are subsequently heat-treated. This is achieved in accordance with the invention preferably using a laser beam source which is unfocused and can thus be used for heat treatment.

This results in the advantage that damaged areas of the sound-reducing sandwich-like arrangement can be restored cost-effectively in such a way that the sound-reducing function is preserved while damage to the wall is ruled out.

The method in accordance with the invention is preferably performed by means of an NC-controlled machine such that exact repair within geometrically predetermined areas can be performed in such a way that a replacement piece made to fit precisely can be inserted into the area to be repaired.

The present invention is more fully described in light of the accompanying drawing showing a preferred embodiment. In the drawing,

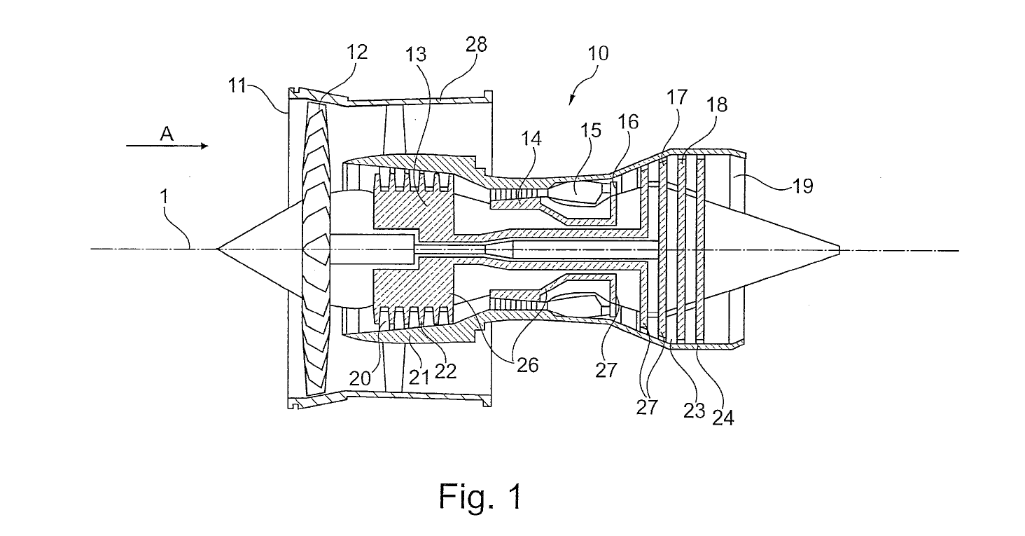

FIG. 1 shows a schematic representation of a gas-turbine engine in accordance with the present invention,

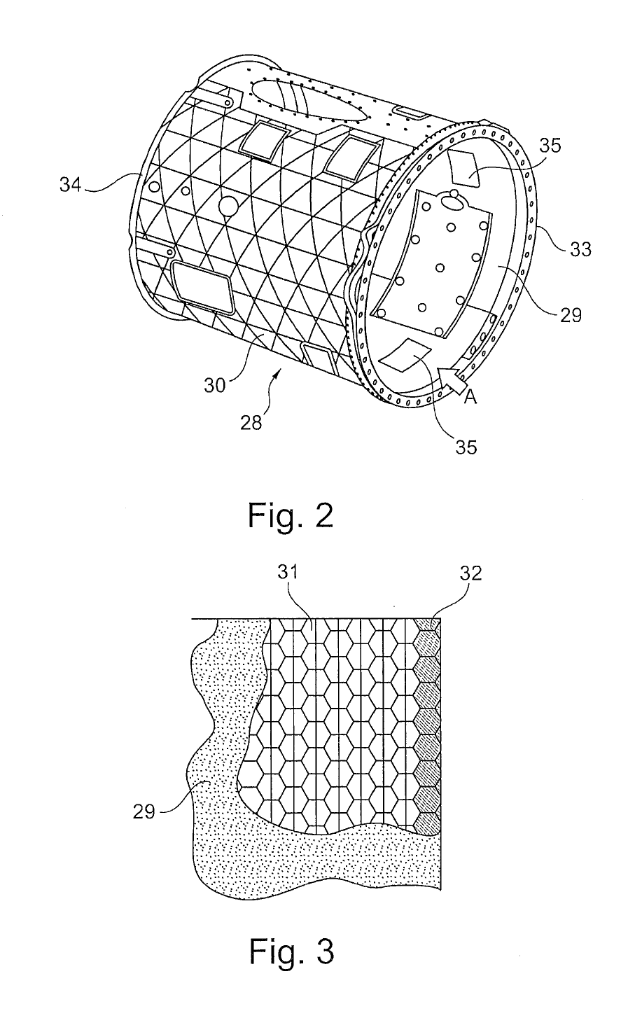

FIG. 2 is a perspective view of a bypass casing,

FIG. 3 shows an enlarged representation as per arrow A of FIG. 2,

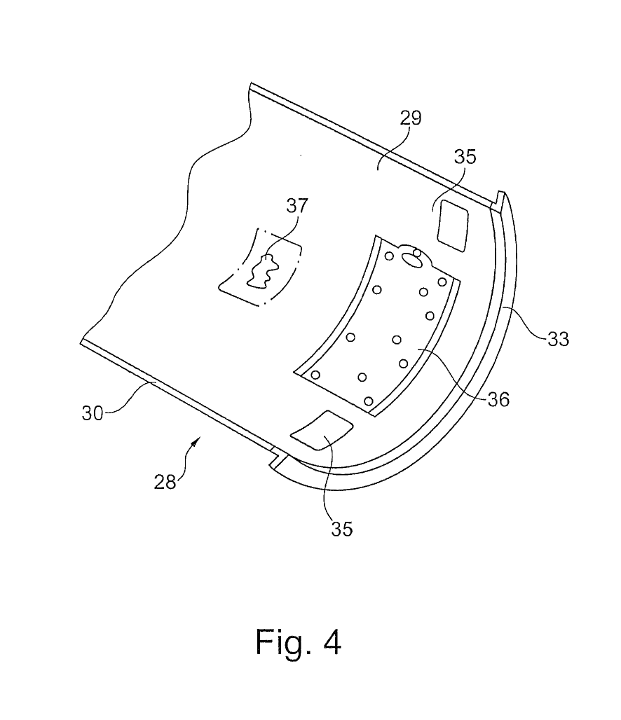

FIG. 4 shows a schematic partial representation of the bypass casing with the top layer damaged,

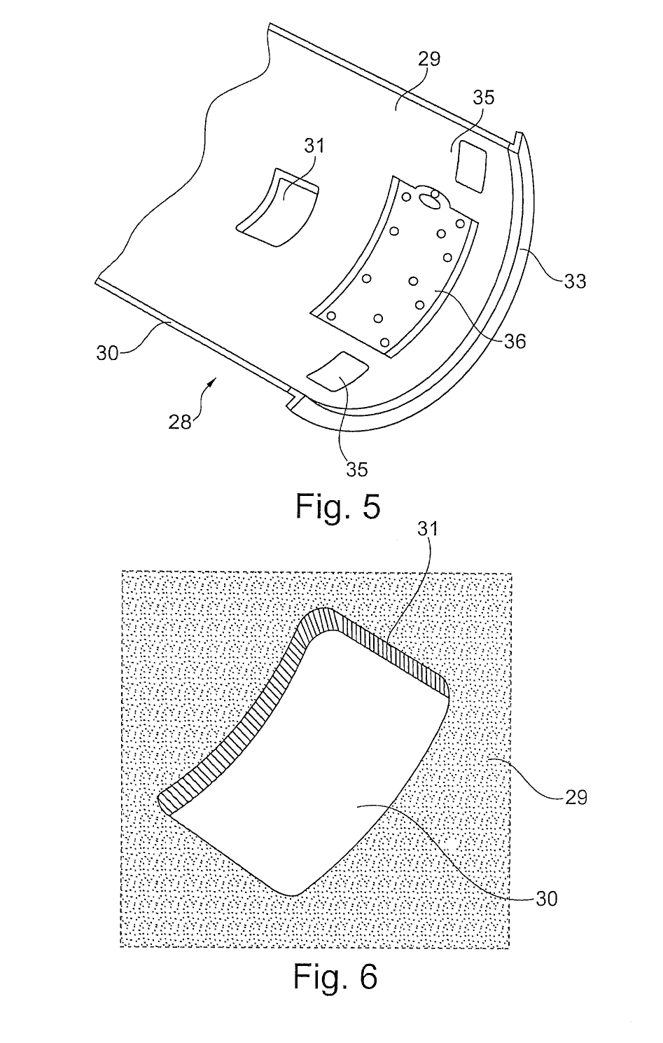

FIG. 5 is a view, similar to FIG. 4, with top layer and honeycomb structure removed,

FIG. 6 is an enlarged detail view as per FIG. 5,

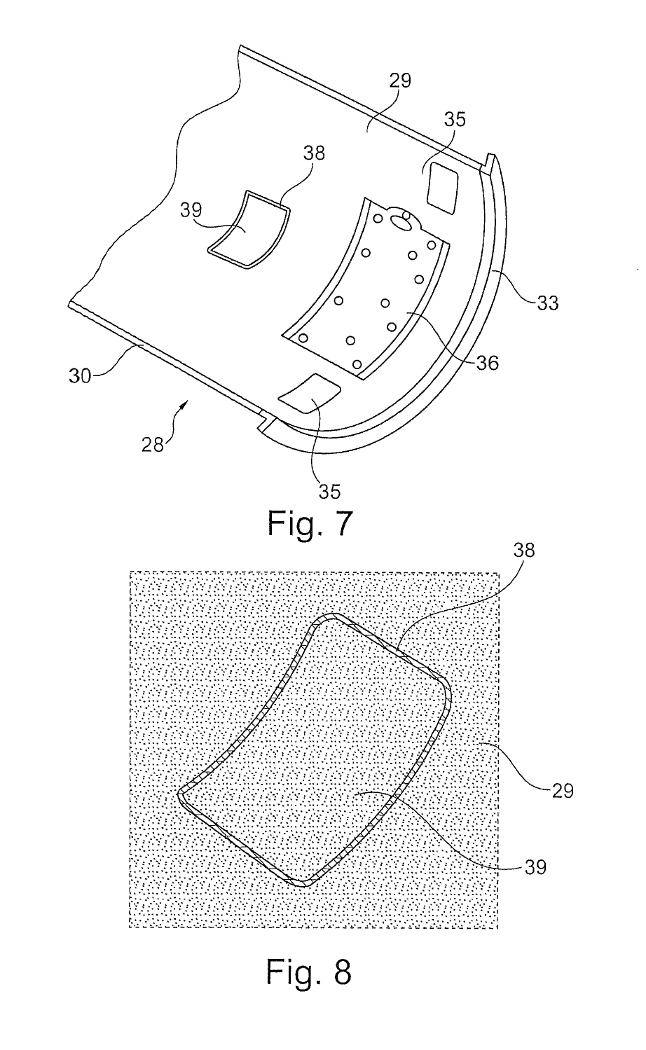

FIG. 7 is a view, similar to FIGS. 4 and 5, with the damaged area repaired,

FIG. 8 is an enlarged detail view as per FIG. 7,

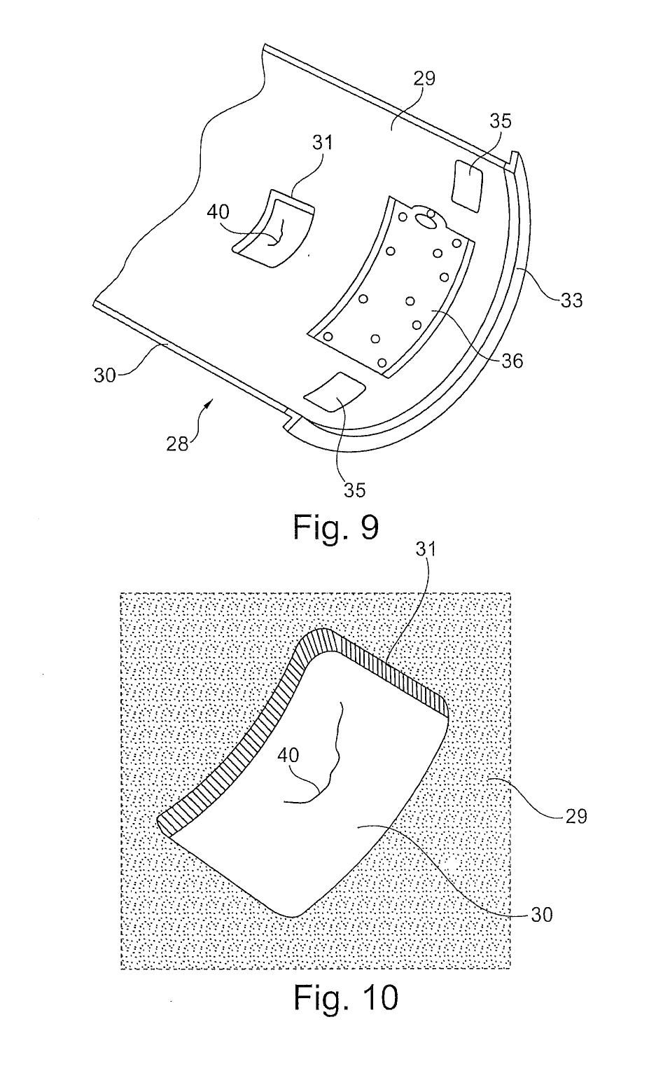

FIG. 9 is a view, similar to FIG. 5, featuring a crack in the wall,

FIG. 10 is an enlarged detail view as per FIG. 9,

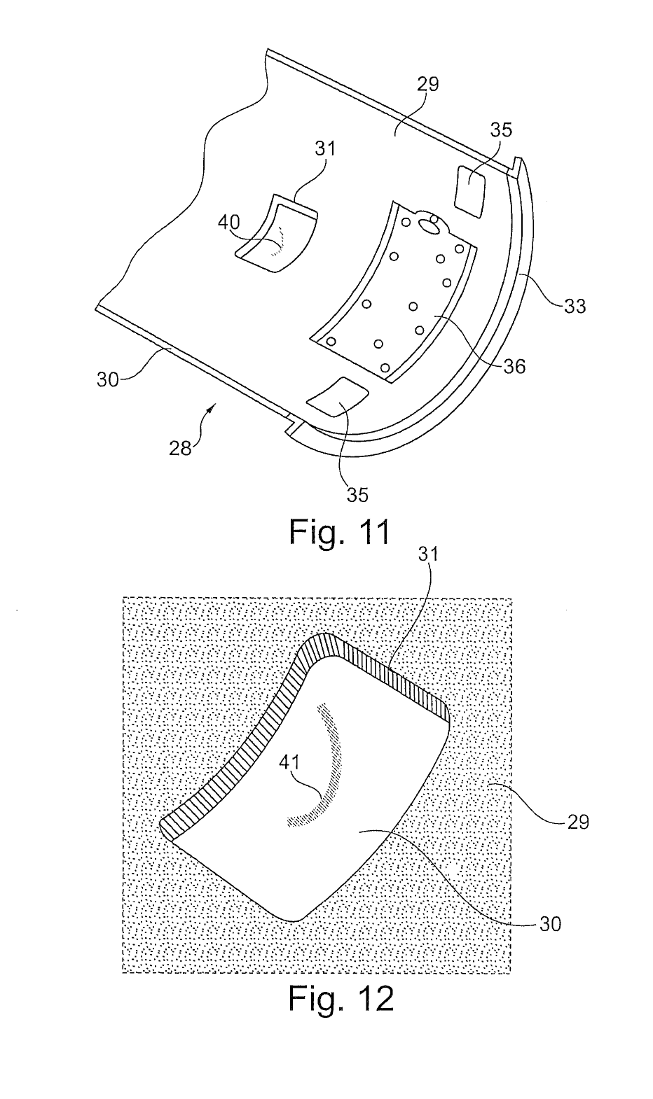

FIG. 11 is a view, similar to FIG. 9, with the crack repaired,

FIG. 12 is an enlarged detail view as per FIG. 11,

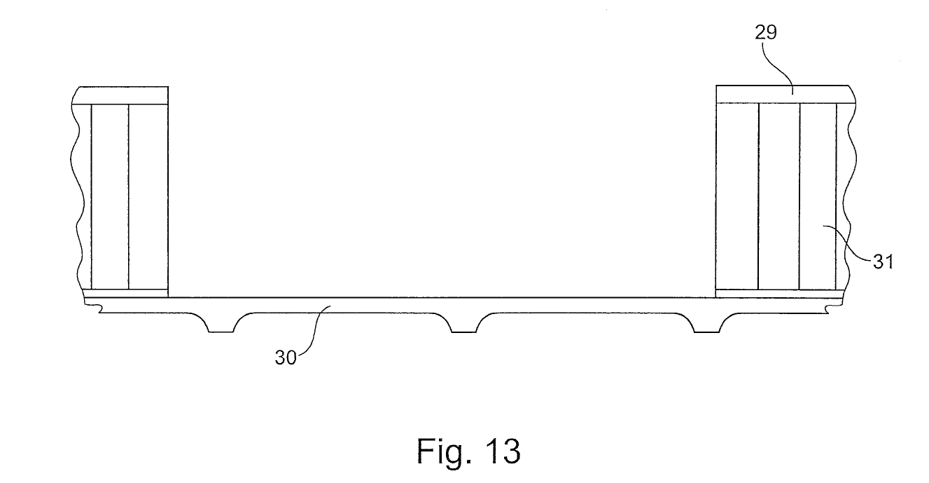

FIG. 13 is a partial sectional view, similar to FIGS. 6 and 10, and

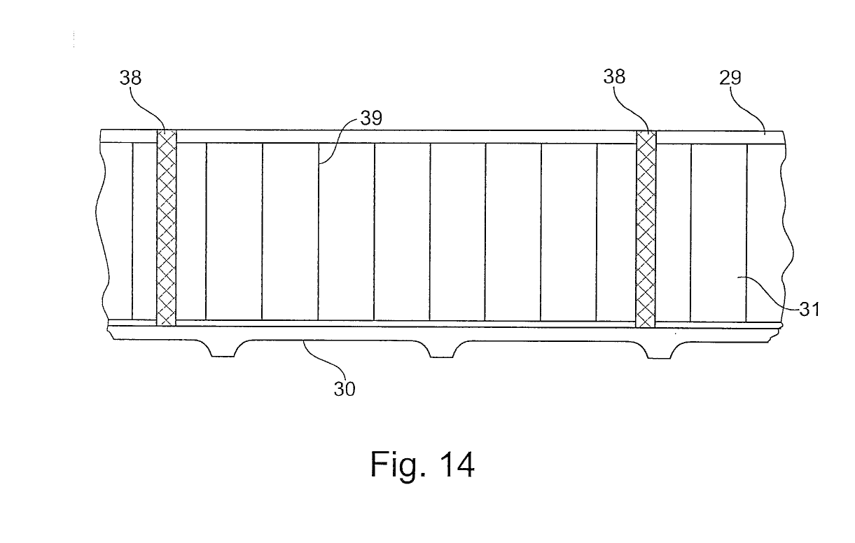

FIG. 14 is a view, similar to FIG. 13, showing the repaired state as per FIG. 8.

The gas-turbine engine 10 according to FIG. 1 is an example for a turbomachine in which the invention can be applied. It is however clear from the following that the invention can also be used for other turbomachines. The engine 10 is designed in the conventional manner and includes, one after the other in the flow direction, an air inlet 11, a fan 12 rotating inside a casing, an intermediate-pressure compressor 13, a high-pressure compressor 14, combustion chambers 15, a high-pressure turbine 16, an intermediate-pressure turbine 17 and a low-pressure turbine 18 plus an exhaust nozzle 19, all arranged around a central engine axis 1.

The intermediate-pressure compressor 13 and the high-pressure compressor 14 each include several stages, each of which has an arrangement of fixed and stationary guide vanes 20 extending in the circumferential direction, generally referred to as stator vanes and projecting radially inwards from the engine casing 21 in an annular flow duct through the compressors 13, 14. The compressors furthermore have an arrangement of compressor blades 22 projecting radially outwards from a rotating drum or disk 26 coupled to hubs 27 of the high-pressure turbine 16 or of the intermediate-pressure turbine 17, respectively.

The turbine sections 16, 17, 18 have similar stages, including an arrangement of fixed guide vanes 23 projecting radially inwards from the casing 21 into the annular flow duct through the turbines 16, 17, 18, and a following arrangement of turbine blades 24 projecting outwards from a rotating hub 27. The compressor drum or compressor disk 26 and the blades 22 arranged thereon, as well as the turbine rotor hub 27 and the turbine blades 24 arranged thereon rotate about the engine axis 1 in operation.

FIG. 2 shows in a perspective and enlarged view an exemplary embodiment of a bypass casing 28 in accordance with the invention. This includes a wall 30 which can be provided with bracing, assembly areas or the like. One each flange 33 or 34, respectively, is connected to the middle area of the bypass casing.

The inner side of the bypass casing 28 is covered by a top layer 29 of perforated design. A honeycomb structure 31 is bonded between the wall 30 and the top layer 29, as shown in simplified form in FIG. 3. Reference numeral 32 in FIG. 3 shows an edge filling for sealing the front edge of the honeycomb structure.

In the repair method in accordance with the invention, the top layer 29 is removed mechanically from the inside of the bypass casing 28, initially in a defined area. At the same time, at least part of the honeycomb structure 31 arranged in the area to be repaired is removed, also for example by a milling or grinding process.

By application of a laser beam, the inner surface of the wall 30 is cleaned of the epoxy resin without leaving traces. Following this it is possible to weld any cracks present and to heat-treat the welded crack area. Subsequently, a prefabricated and precisely fitting replacement piece is bonded in place, and the surface of the top layer 29 can then, if necessary, be smoothed at the transitions and adapted.

FIGS. 4 to 14 show various stages of the repair method for illustration of the invention.

FIG. 4 shows in a partial view, similar to FIG. 2, of a part of the bypass casing 28. Here a damaged area 37 is marked in which either the top layer 29 or also the honeycomb structure 31 are damaged. FIG. 5 shows a view similar to FIG. 4, in which the damaged area has been mechanically removed along the dash-dotted line in FIG. 4. As a result, the honeycomb structure 31 at the edge of the removed area is also discernible. The wall 30 has already been cleaned. FIG. 6 thus shows an area in which the honeycomb structure 31 and the top layer 29 have been removed for insertion of a fitting replacement piece. FIGS. 7 and 8 show the situation after completing the insertion of a repair piece 39. Reference numeral 38 shows an adhesion joint or seal, which can comprise a rubber-like elastic compound, for example fire-resistant silicone.

FIGS. 13 and 14 show the situations of FIGS. 6 and 8 in simplified form in a sectional view.

FIGS. 9 to 12 show a situation in which a crack 40 has occurred in the wall 30 either additionally to a damage to the top layer 29 and/or to the honeycomb structure 31, or independently thereof. FIG. 10 shows that for repairing the crack 40 a part of the top layer 29 and of the honeycomb structure 31 was removed and the wall 30 cleaned as described. Following this, a repair weld of the crack is made. The welded crack 41 is shown schematically in FIGS. 11 and 12. After the crack is welded, the welded crack 41 and area surrounding the welded crack 41 can be heat-treated. This can be achieved using a laser beam source which is unfocused and can thus be used for heat treatment. Subsequently, a repair piece 39 is inserted and bonded in accordance with FIGS. 7 and 8.

The method in accordance with the invention thus permits the repair of thin-walled components made of titanium using laser technology for the purpose of cleaning the component surface or welding cracks with subsequent local heat treatment for reducing residual stresses.

### LIST OF REFERENCE NUMERALS

1 Engine axis
10 Gas-turbine engine
11 Air inlet
12 Fan rotating inside the casing
13 Intermediate-pressure compressor
14 High-pressure compressor
15 Combustion chambers
16 High-pressure turbine
17 Intermediate-pressure turbine
18 Low-pressure turbine
19 Exhaust nozzle
20 Guide vanes
21 Engine casing
22 Compressor blades
23 Guide vanes
24 Turbine blades
26 Compressor drum or disk
27 Turbine rotor hub
28 Bypass casing
29 Top layer
30 Wall
31 Honeycomb structure
32 Edge filling
33 Flange
34 Flange
35 Service openings
36 Opening for accessory (surface cooler)
37 Damaged area
38 Adhesion joint/seal
39 Repair piece
40 Crack
41 Welded crack

What is claimed is:

1. A method for repairing a gas-turbine casing,
the gas-turbine casing having a sandwiched structure including a wall, an intermediate honeycomb structure and a top layer, with the wall, the honeycomb structure and the top layer bonded together by epoxy resin;
the method comprising:
mechanically removing the top layer and the honeycomb structure in an area to be repaired;
afterwards, cleaning a surface of the wall of epoxy resin with a laser beam;
bonding at least one prefabricated replacement piece in place.

2. The method of claim 1, and further comprising, after cleaning of the surface of the wall, closing at least one crack in the wall with a laser beam.

3. The method of claim 2, and further comprising using at least one filler material for closing the crack.

4. The method of claim 3, and further comprising heat treating an area of the wall after closing the crack with an unfocused laser beam to reduce residual stresses.

5. The method of claim 4, and further comprising mechanically removing at least one of the top layer or the honeycomb structure by at least one of a milling process or a grinding process.

6. The method of claim 5, and further comprising using an NC-controlled machine to repair the casing.

7. The method of claim 2, and further comprising heat treating an area of the wall after closing the crack with an unfocused laser beam to reduce residual stresses.

8. The method of claim 7, and further comprising mechanically removing at least one of the top layer or the honeycomb structure by at least one of a milling process or a grinding process.

9. The method of claim 7, and further comprising using an NC-controlled machine to repair the casing.

10. The method of claim 1, and further comprising mechanically removing at least one of the top layer or the honeycomb structure by at least one of a milling process or a grinding process.

11. The method of claim 1, and further comprising using an NC-controlled machine to repair the casing.
